(19) United States
(12) Patent Application Publication
(10) Pub. No.: US 2023/0284772 A1
(43) Pub. Date: Sep. 14, 2023

(54) BOTTLE WITH DIGITAL DISPLAY

(71) Applicant: Consilium Enterprises, Inc., Los Angeles, CA (US)

(72) Inventor: Paolo Del Vecchio, Los Angeles, CA (US)

(73) Assignee: Consilium Enterprises, Inc., Los Angeles, CA (US)

(21) Appl. No.: 17/693,063

(22) Filed: Mar. 11, 2022

(51) Int. Cl. A45F 3/18; G06F 3/147

(52) U.S. Cl. CPC A45F 3/18; G06F 3/147; H04W 4/38

(57) ABSTRACT

A reusable water bottle comprising a cap; a container; a power source; and a digital display; wherein said container comprises a top end and a base; wherein said container is configured to store a liquid; wherein said container comprises a container surface and said digital display is configured to engage said container surface.

### FIELD OF DISCLOSURE

The present disclosure relates to bottles configured to operate as electronic accessories. More specifically, the present disclosure relates to a reusable drinking bottle, with an outward facing flexible digital display embedded in or on the surface of the bottle, such that the display may be configured to display videos, pictures, graphics, information, gifs, and other moving or static images.

### BACKGROUND

Digital accessories are now commonplace, with most individuals having access to a smartphone, among other electronics, at all times. In addition, many individuals also carry other permanent accessories for making their daily life more carbon neutral, such as reusable water bottles. This has become more important as the recognition of the need to move toward green or environmentally friendly alternatives.

Many individuals who carry reusable water bottles with them may enjoy customizing their reusable water bottles with decorative components to express themselves. Additionally, personalization also has the benefit of making an owner's reusable water bottle distinct and easy to identify, which may be important because there are a limited number of styles of popular reusable water bottles.

Therefore, a need exists for reusable water bottles that incorporate electronic components to allow users to customize their liquid bottles and/or broadcast messages to onlookers.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

One embodiment may be a reusable drinking bottle comprising: a container; a power source; and a digital display; wherein the container comprises a top end and a base; wherein the container is configured to store a liquid; wherein the container comprises a container surface and the digital display is configured to engage the container surface; and wherein the digital display is configured to display one or more data files. The reusable drinking bottle may comprise a display cover; wherein the display cover is configured to protect the digital display by substantially covering the digital display; and wherein the display cover is substantially transparent. In some embodiments the container surface, the digital display, and the display cover are curved and/or cylindrical in shape. The reusable drinking bottle may comprise a circuit board; wherein the circuit board may comprise a charging module, a display control, and a power switch; wherein the circuit board is powered by the power source. The circuit board may comprise a wireless communication module. The wireless communication module may be configured to receive one or more electronic signals from a remote electronic device. The one or more electronic signals may comprise one or more of the one or more data files, one or more instructions, and combinations thereof and the one or more data files may comprise videos, pictures, graphics, information, gifs, other moving or static images, or combinations thereof. The power source may be located within the base and the circuit board may be located within the base. The power source may be a battery. The battery may be encased in fireproof foam. The one or more instructions may be configured to cause the one or more data files to be displayed on the digital display. The reusable drinking bottle may further comprise a cap and the top end is configured to engage the cap. The top end may comprise a threaded top portion, the cap may comprise a threaded cap portion, and the top end and the cap may be configured to rotably engage one another via the threaded top portion and the threaded cap portion. The container may comprise a material selected from the group of materials consisting of one or more of: molded plastic, clear molded epoxy, solid molded epoxy, stainless steel, aluminum, and/or combinations thereof. The digital display may be an LED screen.

Another embodiment may be a reusable drinking bottle comprising: a cap; a container; a power source; a digital display; a display cover; and a circuit board; wherein the container comprises a top end and a base; wherein the container is configured to store a liquid; wherein the container comprises a container surface and the digital display is configured to engage the container surface; wherein the display cover is configured to protect the digital display by covering the digital display; wherein the display cover is transparent; wherein the container surface, the digital display, and the display cover are curved; wherein the circuit board comprises a charging module, a display control, and a power switch; wherein the circuit board is powered by the power source; wherein the circuit board comprises a wireless communication module; wherein the wireless communication module is configured to receive one or more electronic signals from a remote electronic device; wherein the one or more electronic signals comprise one or more of one or more data files, one or more instructions, and combinations thereof; wherein the one or more data files comprise videos, pictures, graphics, information, gifs, other moving or static images, or combinations thereof; wherein the one or more instructions are configured to cause the one or more data files to be displayed on the digital display; wherein the power source and the circuit board are located within the base; wherein the power source is a battery; and wherein the battery is encased in fireproof foam.

In accordance with the embodiments disclosed herein, the present disclosure is directed to a portable reusable drinking or water bottle with a digital display.

The system of the present disclosure may comprise a reusable drinking bottle with a digital display, and a circuit board, in order to capitalize on the preferred characteristics of both a reusable water bottle and a digital accessory.

The reusable water bottle of the present disclosure may comprise a battery that may be internally encased in fireproof foam to protect the battery pack from accidental dropping and other potential damage. The circuit board may comprise a charging module, a display control, and a power switch. The reusable water bottle may also comprise a battery status indicator, such as a light having different intensities or colors to represent charge level of the battery. The circuit board may control the digital display and may be powered by the battery.

In one embodiment, the circuit board may further comprise a wireless control device, such as a radio frequency identification device (RFID) and short-range wireless interconnection. This may allow a user to remotely control what may be displayed on the digital display. Additionally, the wireless control device may allow a user to remotely turn the digital display on and off.

In another embodiment, the circuit board may further comprise a central processing unit (CPU), a video processor (GPU), and memory storage device, such as a solid-state memory storage device. This may allow a user access to greater processing power and increased functionality of the device for display of photos, videos, gifs, information, and the like.

In another embodiment, the digital display may be SMB LEDs, and individual LED diodes. In another embodiment, the digital display may be LED diodes in the format of a panel. In other embodiments, the digital display may be OLED screens, plasma screens, and full array LED screens. In other embodiments, the digital display may be an EL panel. It is understood that different types of digital displays may be selected for optimized performance under particular conditions.

In another embodiment, the display cover may be a transparent material configured to allow light to pass through. The display cover may be molded plastic, clear molded epoxy, or solid molded epoxy. Different materials may be utilized depending on particular qualities desired.

In another embodiment, the charging module may comprise a charging port such as micro-USB, Apple 40 pin/lightening, USB-C charging port, and/or a solar charger. The different types of charging ports may allow for compatibility with a consumer's existing charging hardware, so that the reusable water bottle may be charged with pre-existing cables. In another embodiment, the charging module may be a wireless inductive charging system. The charging module and ports allow the battery or power source to be charged and recharged to allow the digital display the power needed to perform.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a reusable bottle.

FIG. 2 is a cross sectional view of the reusable water showing the relationship between the container surface, digital display, and display cover.

FIG. 3 is an illustration of one embodiment of the base, showing the components of the circuit board for use with the reusable bottle.

FIG. 4 is an illustration of another embodiment of a reusable bottle.

FIG. 5 is an illustration of another embodiment of a reusable bottle.

FIG. 6 is an illustration of a bottom view of a base for use with a reusable bottle.

### DETAILED DESCRIPTION OF THE ILLUSTRATIVE EMBODIMENTS

In the following detailed description of various embodiments, numerous specific details are set forth in order to provide a thorough understanding of various aspects of the embodiments. However, these embodiments may be practiced without some or all of these specific details. In other instances, well-known methods, procedures, and/or components have not been described in detail so as not to unnecessarily obscure aspects of the embodiments.

While multiple embodiments are disclosed, still others will become apparent to those skilled in the art from the following detailed description. As will be realized, these embodiments are capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about,” may refer to a deviance of between 0.0001-40% from the indicated number or range of numbers.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signify both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments. It is to be understood that the methods and systems are not limited to specific methods, specific components, or to particular implementations. It is also to be understood that the terminology used herein is for the purpose of describing particular embodiments only and is not intended to be limiting.

Embodiments of the present disclosure generally relate to the field of reusable drinking or water bottles with digital displays.

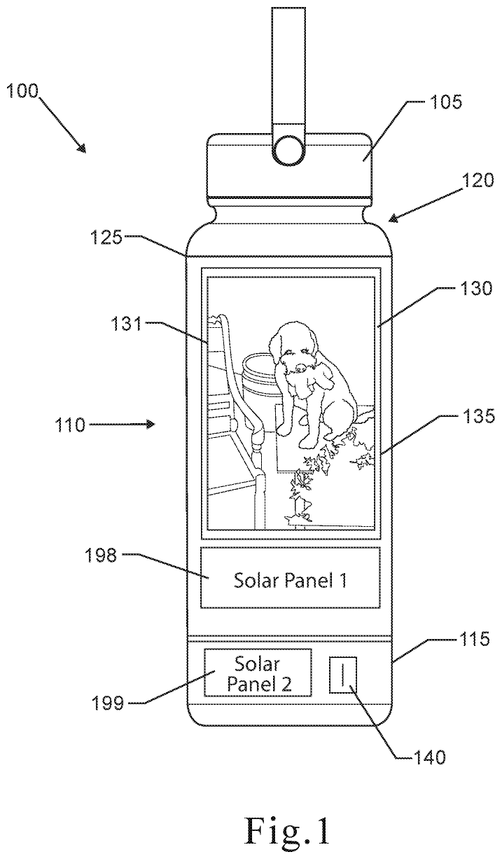

FIG. 1 is an illustration of one embodiment of a reusable water bottle. As shown in FIG. 1, the reusable bottle 100 may comprise a cap 105, container 110, and base 115. The container 110 may comprise a top end 120, and the cap 105 may be configured to engage the top end 120. In one embodiment, the container 110 may preferably comprise a non-porous material, such as molded plastic, clear molded epoxy, solid molded epoxy, stainless steel, aluminum, and other waterproof materials.

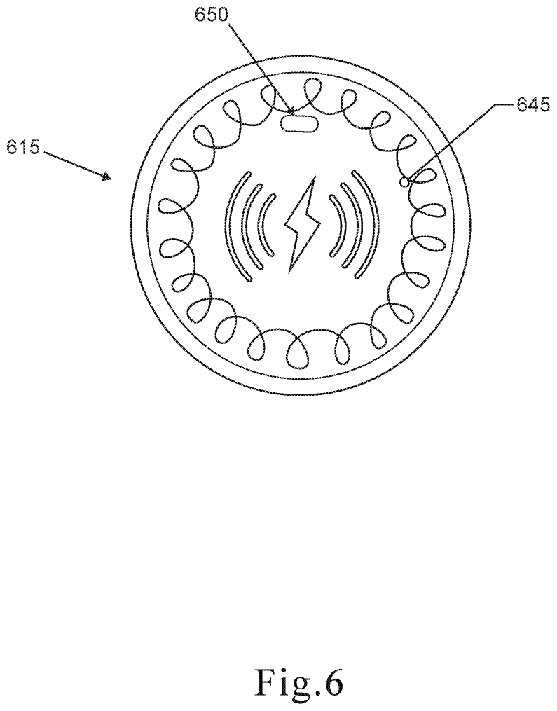

The container 110 may comprise a container surface 125. A digital display 130 may be located on the container surface 125. The digital display 130 may partially, substantially completely, or completely cover the container surface 125. In some embodiments, the digital display 130 may be configured to cover specific portions of the container surface 125, depending on specific design. The digital display 130 may be substantially any type of electronic display, including, but not limited to LED screens, SMB LEDs, individual LED diodes, LED diodes in the format of a panel, OLED screens, plasma screens, full array LED screens, EL panels, and the like. In some embodiments, the digital display 130 may also cover a portion of the base 115, as shown in FIG. 6. In some embodiments, the digital display 130 may be soft or flexible. In other embodiments, the digital display 130 may be rigid.

In some embodiments, the digital display 130 may be partially or completely covered by a display cover 135. The display cover 135 may preferably be a partially or completely transparent material, such that the digital display 130, when active, may be viewable by an observer.

As shown in FIG. 1, the digital display 130 may display a data file, such as a photograph, image, reoccurring video clip (gif), or video 131.

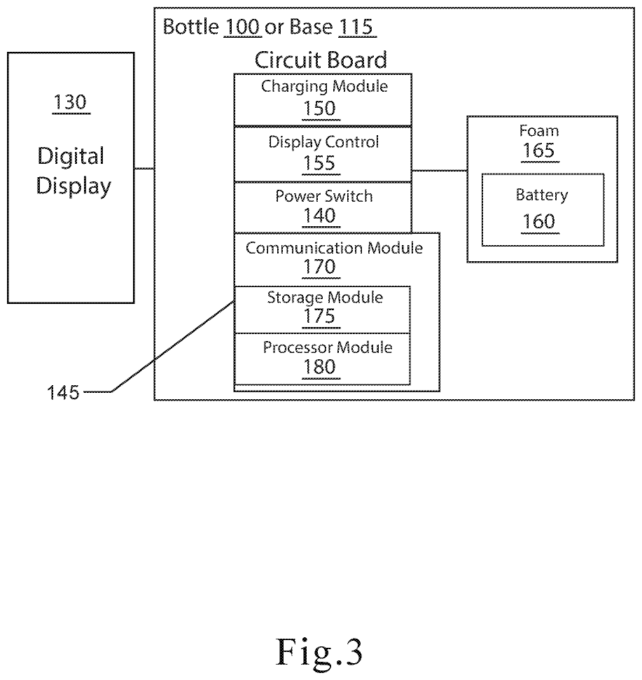

The base 115 may also comprise a circuit board 145 (see FIG. 3). In one embodiment, the circuit board 145 may comprise a charging module 150, display control 155, power switch 140, and communication module 170. The power switch 140 may be accessible from outside the base 115. In a preferred embodiment, the base 115 may also comprise a battery 160. The battery may be protected by or encased in a protective structure 165. In one embodiment, the protective structure 165 may be a fire resistant foam. The battery 160 may be used to power the digital display 130, as well as components of the circuit board 145. The display control 155 may be configured to determine what images, video, or materials are displayed on the digital display 130 and to generate and send the appropriate signals.

The charging module 150 may be a wired or wireless charging module. Power may be supplied to the charging module 150, which may then cause the battery 160 to be charged. If the charging module 150 is a wired charging module, then the charging module 150 may comprise a charging inlet configured in the format of mini-usb, micro-usb, usb-a, usb-c, or substantially any other charging structure. The charging module 150 may be a wireless charging module, such as an inductive wireless charging protocol.

The circuit board 145 may also comprise a communication module 170. The communication module 170 may be configured to communicate with a remote device, such as a smart phone, laptop, desktop, tablet, or other electronic computing device, such that the remote device may send to the reusable water bottle 100 instructions and/or commands to cause the digital display 130 to activate, deactivate, or display static or moving images on the digital display 130. The communication module 170 may be a wireless communication module, as preferred, or a wired communication module. In one embodiment, the communication module 170 may receive communication through the charging module 150, if the charging module 150 is a wired charging module. In one embodiment, the communications may comprise one or more electronic signals from a remote electronic device. The electronic signals may comprise one or more data files, one or more instructions, or combinations thereof. The data files may comprise videos, pictures, graphics, information, gifs, other moving or static images, or combinations thereof. The wireless communication may be through a short-range wireless technology standard, such as Bluetooth®, a near field communication, or other wireless/wifi mechanisms.

In some embodiments, the reusable water bottle 100 may comprise a storage module 175 configured to store images, video, or other materials to be displayed on the digital display 130. In some embodiments, the storage module 175 may be a part of the circuit board 145, or may be in electronic communication with the circuit board 145 and/or digital display 130. The storage module 175 may be a solid state memory storage device. The storage module 175 may also comprise a computer processing unit and a video processor, which may allow for more complex use of the digital display 130. In some embodiments, the digital display 130 may display streaming content that is delivered wirelessly to the digital display 130 through the communication module 170.

The cap end 120 and the cap 105 may comprise threads to threadably engage one another, thereby sealing the reusable water bottle 100 and preventing the contents of the container 110 from spilling out. While the reusable bottle 100 may be configured to store water, it is understood that other liquids may be stored, such as soup, hot beverages, cold beverages, or even solid materials such as various foodstuffs. Other engagement systems may be used, such as friction, latches, or other types of connectors.

In some embodiments, the base 115 and container 110 may be distinct components configured to lockingly or releasably engage one another. In other embodiments, the base 115 and container 110 may comprise a unitary structure having a separating piece or portion configured to prevent the contents of the container 110 from coming into contact with the components housed within the base 115. In other embodiments, the electronic components may be held within the sides of the container 110.

FIG. 1 shows that the bottle 100 may comprise one or more solar panels 198, 199, which may be on the container 110 or the base 115.

The digital display 130 may cover a discrete portion of the container 110 or it may wrap around the entire container 110.

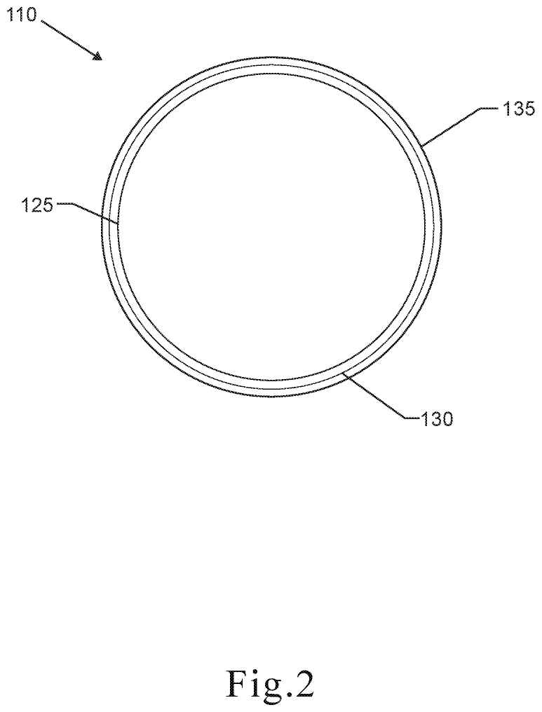

FIG. 2 is a cross sectional view of the reusable water bottle showing the relationship between the container surface, digital display, and display cover. As shown in FIG. 2, the container surface 125, digital display 130, and display cover 135 may be similar in shape, such that the digital display 130 is sandwiched between the container surface 125 and display cover 135. In some embodiments, the display cover 135 may not be present, or may be configured to be removable from the digital display 130. In other embodiments, the digital display 130 and display cover 135 may not be present or may be configured to be removable from the container surface 125.

In one embodiment, the container surface 125 may be made of molded plastic, clear molded epoxy, solid molded epoxy, stainless steel, aluminum, and similar waterproof alloys. Preferably, the container surface 125 may be configured to contain a liquid on an interior and engage or support a digital display 130 on the exterior.

In one embodiment, the display cover 135 may be made of a transparent material configured to allow some amount of light to pass through. In a preferred embodiment, the display cover 135 may be waterproof and/or shock resistant.

FIG. 2 shows that the cover and digital display may cover the entire circumference of container 110.

FIG. 3 is an illustration of one embodiment of the base, showing the components of the circuit board for use with the reusable water bottle. As shown in FIG. 3, the circuit board 145 may comprise the charging module 150, display control 155, power switch 140, and communication module 170. The circuit board 145 may also comprise the battery 160, along with the protective structure 165.

The circuit board 145 may be in electronic communication with the digital display 130, such that the circuit board 145, and its various components, send electronic communications (wired or wireless) to the digital display 130 to cause the digital display 130 to show images, video, and other materials.

In one embodiment, the circuit board 145 may comprise the storage module 175 configured to store the images, video, or other materials to be shown on the digital display.

The battery 160 may be configured to provide power to the circuit board 145 and/or the digital display 130.

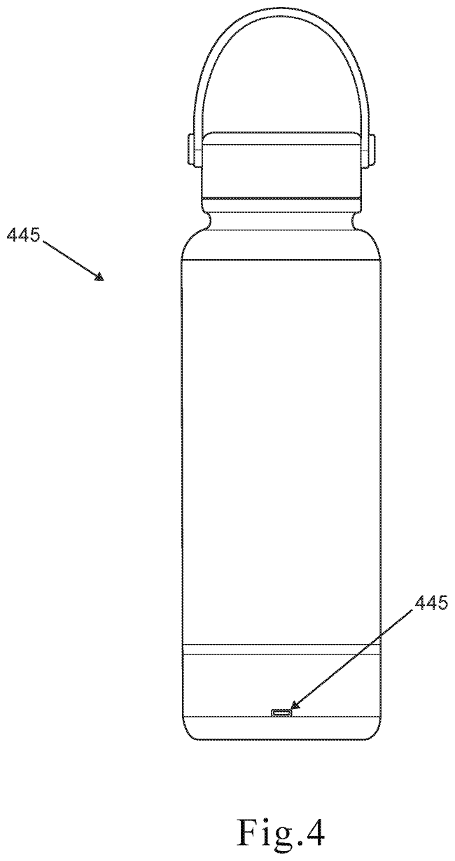

FIG. 4 is an illustration of another embodiment of a reusable water bottle. The reusable bottle 400 may be substantially similar to the liquid bottle 100 shown and described in FIGS. 1-3, with the primary difference being that the reusable bottle 400 shown in FIG. 3 comprises a power inlet 445 configured to receive a charging cable in order to charge a battery of the reusable bottle 400.

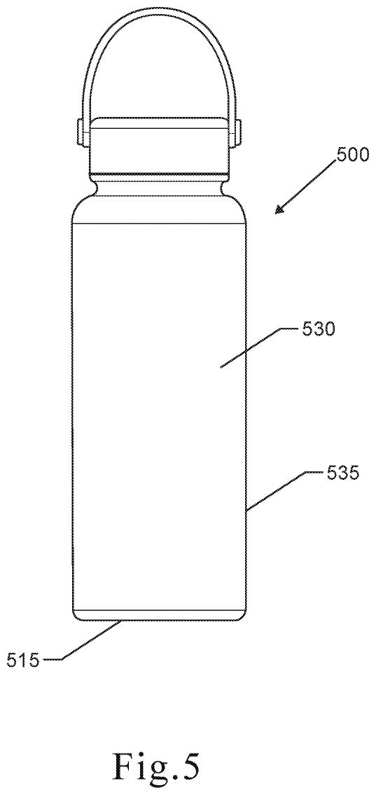

FIG. 5 is an illustration of another embodiment of a reusable drinking bottle. The reusable drinking bottle 500 may be substantially similar to the bottle 100 shown and described in FIGS. 1-3, with the primary difference being that the drinking bottle 500 shown in FIG. 5 comprises a digital display 530 and display cover 535 that substantially covers a container surface 510 and base 515 of the reusable water bottle 500. One advantage of this embodiment may be that the digital display 530 is larger compared to the digital display 130 shown in FIG. 1. Another advantage of this embodiment may be that the base 515 may be protected by the digital display 530 and display cover 535. Accordingly, to the extent that fragile electronic components are housed within the base 515, they may be more effectively protected from damage. This also provides for a larger digital display 530.

FIG. 6 is an illustration of a bottom view of a base for use with a reusable water bottle. As shown in FIG. 6, the base 615 may comprise a wired charging module 650 as well as a wireless charging module 645. The base 615 may be substantially similar to the base 100 disclosed in FIGS. 1-3, with the primary difference being that the wired charging 650 and wireless charging module 645 function as a replacement for the charging module 150.

Although the bottles shown in the figures are preferably personal rehydration bottles, it should be understood that the bottles may be larger or smaller, including communal reusable hydration containers and taps. It should also be understood the drinking bottles shown may hold any liquid or solid food item.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded. As illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A reusable drinking bottle comprising:
a container;
a power source; and
a digital display;
wherein said container comprises a top end and a base;
wherein said container is configured to store a liquid;
wherein said container comprises a container surface and said digital display is configured to engage said container surface; and
wherein said digital display is configured to display one or more data files.

2. The reusable drinking bottle of claim 1, further comprising a display cover;
wherein said display cover is configured to protect said digital display by substantially covering said digital display; and
wherein said display cover is substantially transparent.

3. The reusable drinking bottle of claim 2, wherein said container surface, said digital display, and said display cover are curved.

4. The reusable drinking bottle of claim 2, wherein said container surface, said digital display, and said display cover are cylindrical in shape.

5. The reusable drinking bottle of claim 1, further comprising a circuit board;
wherein said circuit board comprises a charging module, a display control, and a power switch;
wherein said circuit board is powered by said power source.

6. The reusable drinking bottle of claim 5, wherein said circuit board comprises a wireless communication module.

7. The reusable drinking bottle of claim 6, wherein said wireless communication module is configured to receive one or more electronic signals from a remote electronic device.

8. The reusable drinking bottle of claim 7, wherein said one or more electronic signals comprise one or more of said one or more data files, one or more instructions, and combinations thereof;
wherein said one or more data files comprise one or more of the following: videos, pictures, images graphics, information, gifs, and combinations thereof.

9. The reusable drinking bottle of claim 1, wherein said power source is located within said base; and
wherein said circuit board is located within said base.

10. The reusable drinking bottle of claim 9, wherein said power source is a battery.

11. The reusable drinking bottle of claim 10, wherein said battery is substantially enclosed in fireproof foam.

12. The reusable drinking bottle of claim 8, wherein said one or more instructions are configured to cause said one or more data files to be displayed on said digital display.

13. The reusable drinking bottle of claim 1, further comprising a cap;
wherein said top end is configured to engage said cap.

14. The reusable drinking bottle of claim 13, wherein said top end comprises a threaded top portion;
wherein said cap comprises a threaded cap portion; and
wherein said top end and said cap are configured to rotably engage one another via said threaded top portion and said threaded cap portion.

15. The reusable drinking bottle of claim 1, wherein said container comprises a material selected from the group of materials consisting of one or more of:
molded plastic, clear molded epoxy, solid molded epoxy, stainless steel, aluminum, and combinations thereof.

16. The reusable drinking bottle of claim 1, wherein said digital display is an LED screen.

17. A reusable drinking bottle comprising:
a cap;
a container;
a power source;
a digital display;
a display cover; and
a circuit board;
wherein said container comprises a top end and a base;
wherein said container is configured to store a liquid;
wherein said container comprises a container surface and said digital display is configured to engage said container surface;
wherein said display cover is configured to protect said digital display by covering said digital display;
wherein said display cover is transparent;
wherein said container surface, said digital display, and said display cover are curved;
wherein said circuit board comprises a charging module, a display control, and a power switch;
wherein said circuit board is powered by said power source;
wherein said circuit board comprises a wireless communication module;
wherein said wireless communication module is configured to receive one or more electronic signals from a remote electronic device;
wherein said one or more electronic signals comprise one or more of one or more data files, one or more instructions, and combinations thereof;
wherein said one or more data files comprise one or more of the following:
videos, pictures, images graphics, information, gifs, and combinations thereof;
wherein said one or more instructions are configured to cause said one or more data files to be displayed on said digital display;
wherein said power source and said circuit board are located within said base;
wherein said power source is a battery; and
wherein said battery is encased in fireproof foam.
